(19) United States
(12) Patent Application Publication
(10) Pub. No.: US 2015/0154360 A1
(43) Pub. Date: Jun. 4, 2015

(54) SYSTEMS AND METHODS FOR SECURE EXCHANGES OF INFORMATION

(71) Applicant: CAREMERGE, LLC, CHICAGO, IL (US)

(72) Inventors: FAHAD AZIZ, CHICAGO, IL (US); MICHAEL DAVOLT, CHICAGO, IL (US); ASIF KHAN, OAK PARK, IL (US)

(21) Appl. No.: 14/558,522

(22) Filed: Dec. 2, 2014

Related U.S. Application Data
(60) Provisional application No. 61/910,572, filed on Dec. 2, 2013.

(51) Int. Cl. G06F 19/00; G06F 21/62; H04L 29/06; H04L 29/08

(52) U.S. Cl. CPC G06F 19/322; H04L 67/12; G06F 21/6245; H04L 63/08; H04L 63/105

(57) ABSTRACT

The disclosure herein pertains to systems and methods for communicating information regarding patients which include authorizing a plurality of care providers to access an informational interface specific to a patient by assigning each care provider an access security level and an input level, and authorizing a plurality of recipients to access the informational interface. Information specific to the patient is received from a first care provider and transmitted to the informational interface and/or at least one of the authorized recipients based on the input level of the first care provider. The information in the interface is displayed to at least one of the care providers based on the access security level of the care provider, and is displayed to at least one of the authorized recipients.

### CROSS-REFERENCE TO RELATED APPLICATIONS

This applications claims priority to U.S. Provisional Patent Application Ser. No. 61/910,572, filed Dec. 2, 2013, which is hereby incorporated by reference in its entirety.

### FIELD OF THE INVENTION

Embodiments usable within the scope of the present disclosure relate, generally, to systems and methods for data transmission, storage, presentation, and access between authorized parties, and more specifically, to systems and methods for interfacing and exchanging information between medical personnel, care providers and/or caretakers, and other authorized individuals in a manner compliant with the Health Insurance Portability and Accountability Act (“HIPAA”), which is hereby incorporated by reference in its entirety.

### BACKGROUND OF THE INVENTION

Due to HIPAA, the communication and transmission of information relating to the medical care of a patient is significantly restricted. Most notably, personal and/or individually identifiable healthcare information can only be provided to personnel directly involved in the patient's treatment and/or payment therefore, health care clearinghouses (under certain circumstances), and individuals specifically authorized by the patient, or an individual having medical power of attorney for the patient. As a result, in various types of medical facilities, including, by way of example, facilities focused on care for the elderly (e.g., nursing homes, assisted living facilities, skilled nursing facilities, hospice centers, home health providers, etc.), communication between medical personnel, family members, and other individuals involved in a patient's care, can be inefficient, sporadic, and/or disorganized.

Due to the legal constraints placed on the accessibility of healthcare-related information, centralized and/or publicly accessible sources of individually identifiable healthcare information cannot be used, and the majority of communications between individual medical providers, caretakers, individual family members, and/or other involved persons occur in a manner that is not recorded for future access, frequently without the knowledge of other medical personnel and/or relatives/caretakers. Missed communications, incomplete information, and redundant/repetitive information frequently result from such circumstances.

For example, verbal conversations, both by telephone and in person, between a staff member at a facility (e.g., a medical provider) and an individual family member of a patient are typically not recorded. Many times, care providers and family members will have no knowledge regarding which individuals have spoken to whom and whether the information most recently received by any individual is the most current information. Electronic communications (e.g., e-mail and/or text/short message service (“SMS”) messages) between medical providers/facilities and family members and/or other individuals involved in a patient's care are typically recorded; however, such communications are normally stored on a single individual's device in a manner that is not accessible to other individuals involved in a patient's care. Additionally, HIPAA regulations impose restrictions on the use of voicemail, e-mail, and text/SMS when transmitting personal health information.

Even when the privacy of personal health information is not directly at risk, it is desirable for many types of information related to a patient to remain secure, accessible only by authorized individuals. For example, planning and execution of one or more activities intended to improve patient wellness by an elderly care facility typically requires the communication of relevant dates, times, locations, and other such information to staff members, patients, patient relatives, and other individuals involved in patient care, as well as the production of a record regarding the attendance of specific patients at various events. While a portion of the information relating to such activities may not constitute personal health information covered by HIPPA, it may remain desirable to ensure the security of information relating to a patient's whereabouts and activities, and to maintain the security of information relating to the activities of a healthcare facility to allow for the possibility that healthcare-related information may inadvertently be discussed/communicated.

### BRIEF SUMMARY OF THE INVENTION

Embodiments usable within the scope of the present disclosure relate, generally, to systems, methods, and computer instructions (e.g., applications, software, etc.) usable to designate one or more individuals associated with a patient (e.g., selected family members, etc.) as authorized individuals that are granted access to patient-specific information, and to denote one or more care providers (e.g., medical providers, staff members at a facility, caretakers, etc.) as individuals authorized to access a least a portion of information specific to a particular patient. For example, a plurality of individuals may be provided with differing levels of authorization/access, e.g., at an elderly care facility, medical providers may have access to all information relating to a patient, while activity planners may lack access to personal health information, and maintenance personnel may only be granted access to information relating to a patient's lodgings, and the like. Different care provider may also be provided with differing input levels with regard to the system. For example, a medical provider may have sufficient access to input healthcare and treatment-related information, while an activity planner may be restricted to inputting information related solely to facility activities and a patient's attendance thereto.

As information specific to a patient is captured (e.g., recorded by medical and/or other personnel that treat, observe, and/or otherwise interact with a patient, and/or recorded automatically by monitoring devices), that information can be contemporaneously or subsequently transmitted to a centralized informational interface. The type of information that can be captured and transmitted to the interface can be restricted by the access and/or input level of the individual inputting the information. Once the information has been transmitted to the informational interface, one or more authorized individuals (e.g., a medical provider, a facility staff member/employee, a relative of the patient, or other authorized person) can access the informational interface to review a generally continuous, updated collection of information specific to the patient.

In an embodiment, one or more portions of the information may be restricted from access to certain individuals, depending on the level of authorization/access granted to that individual. For example, medical providers responsible for a patient's treatment may have access to all information relating to a patient, while activity planners associated with a facility may only have access to a patient's schedule and any restrictions on activities. Similarly, maintenance personnel may only be allowed an access level sufficient to access information on a patient's room or features of a facility associated with the patient. In a similar manner, if desired, informational access can be restricted from certain family members and/or other authorized individuals as well. In an embodiment, the patient, himself or herself, may also be allowed access and input levels to the interface sufficient to allow him/her to receive and/or input information.

In an embodiment, the informational interface can take the form of a HIPAA-compliant chat interface, in which information regarding a patient's treatment, payment, etc. can be published using the informational interface, and viewed by family members and/or other authorized individuals associated with the patient. Authorized individuals can, in turn, submit questions, comments, notes, photographs, video and audio clips, and/or additional information to the informational interface for access by other individuals, thereby effectively creating a dialogue between care providers and authorized individuals associated with the patient in which all parties can view, at a single source, communications between one another. In effect, the interface can be used to facilitate real-time and/or contemporaneous interaction between care providers and/or caretakers, the patient, family members, and/or any other authorized individuals, while remaining compliant with HIPAA by restricting access to the interface to individuals authorized to access a patient's healthcare information.

In an embodiment, the informational interface can take the form of an activity-related application, in which a facility staff member and/or other individuals can publish information relating to one or multiple activities/events (e.g., using calendar software), including, for example, an activity title, date, location, and other notes, and/or the health benefits of the activity (e.g., the “Dimensions of Wellness”). Patients and/or other attendees can be registered to attend an event using the informational interface.

In an embodiment, the informational interface can transmit a reminder to one or more registered attendees at a preset time interval prior to a scheduled event (e.g., via e-mail, a text/SMS message, a voice message, a communication via a mobile application, or other types of media). For example, a hyperlink or other method of accessing the informational interface can be provided to a individual via an e-mail or text/SMS message. When an individual attends an event, that attendance can be recorded (e.g., by a staff member or an attendance device), and in an embodiment, notifications of attendance can be published using the informational interface and/or sent directly to authorized individuals (e.g., via text/SMS message, e-mail, a hyperlink transmitted via text/SMS message or e-mail, voice message, communication via a mobile application, etc.). Attendance records may be tracked (e.g., by event) and reported, automatically or manually. For activities where health benefits (e.g., “Dimensions of Wellness”) are recorded, attendance can be tracked/reported using the “Dimensions of Wellness” or similar criteria.

In various embodiments, a care provider or other authorized individual may broadcast information to multiple authorized recipients simultaneously. For example, a medical provider could provide updates to multiple family members of a patient and/or other associated care providers regarding a patient's health status, or a facility staff member could broadcast a reminder regarding an upcoming activity to facility employees, patients, and/or relatives/caretakers associated with a patient. Such broadcasts can take the form of voice messages, text/SMS messages, e-mails, transmission of hyperlinks or similar means of access, a message communicated through a mobile application, or any other suitable medium of communicating such information.

### BRIEF DESCRIPTION OF THE FIGURES

The novel features believed characteristic of the disclosed subject matter will be set forth in the claims included herein. The disclosed subject matter itself, however, as well as a preferred mode of use, further objectives, and advantages thereof, will best be understood by reference to the following detailed description of an illustrative embodiment when read in conjunction with the accompanying Figures (“FIG(s)”), wherein:

FIG. 1 depicts a diagrammatic view of an embodiment of a system for the secured exchange of information usable within the scope of the present disclosure.

FIG. 2 depicts an embodiment of a method usable within the scope of the present disclosure.

FIG. 3 depicts an alternate embodiment of a method usable within the scope of the present disclosure.

FIG. 4 depicts an embodiment of a method usable within the scope of the present disclosure, wherein the information being exchanged concerns care locations related to a patient.

FIG. 5 depicts an alternate embodiment of a method usable within the scope of the present disclosure, wherein the information being exchanged concerns care locations related to a patient.

FIG. 6 depicts an embodiment of a method usable within the scope of the present disclosure, wherein the system is used to enable authorized individuals to contribute to a mutual fund for the benefit of a patient.

FIG. 7 depicts an embodiment of a method usable within the scope of the present disclosure, wherein the system may be used to enable authorized individuals to monitor information related to a mutual fund for the benefit of a patient.

FIG. 8 depicts a flowchart of an exemplary manner in which authorizations for access to information stored in the system may be supplied to individuals who did not previously possess such authorization.

FIG. 9 depicts an embodiment of a method usable within the scope of the present disclosure, wherein the system may be used to enable authorized individuals to contribute to and/or view information in the form of a journal, depending on their access level.

FIG. 10 depicts an embodiment of a method usable within the scope of the present disclosure, wherein the system may be used to enable authorized individuals to contribute to and/or view information in the form of notes, depending on their access level.

One or more embodiments are described below with reference to the listed Figures.

### DETAILED DESCRIPTION OF ILLUSTRATIVE EMBODIMENTS

Reference now should be made to the included Figures, in which the same reference numbers are used throughout the different Figures to designate the same components.

Before describing selected embodiments of the subject matter contained in the present disclosure in detail, it is to be understood that the scope of the claimed matters is not limited to the particular embodiments described herein. The disclosure and descriptions herein are illustrative and explanatory of one or more presently preferred embodiments and variations thereof, and it will be appreciated by those skilled in the art that various changes in the design, organization, order of operation, means of operation, equipment structures and location, methodology, and use of mechanical equivalents may be made without departing from the spirit of the disclosure.

Additionally, it should be understood the Figures are intended to illustrate and plainly disclose presently preferred embodiments of the invention to one of skill in the art, and are not intended to be manufacturing level drawings or renditions of final products. Therefore, the Figures may include simplified conceptual views as desired for an easier and more rapid understanding or explanation of the invention. Furthermore, the relative size and arrangement of the components may differ from that shown and still operate within the spirit of the invention as described throughout the present disclosure.

Moreover, it will be understood that various directions such as “upper”, “lower”, “bottom”, “top”, “left”, “right”, and so forth are made only with respect to explanation in conjunction with the Figures, and that the components may be oriented differently, for instance, during transportation and manufacturing as well as operation. Because many varying and different embodiments may be made within the scope of the inventive concept(s) taught herein, and because many modifications may be made in the embodiments described herein, it is to be understood that the details herein are to be interpreted as illustrative and non-limiting.

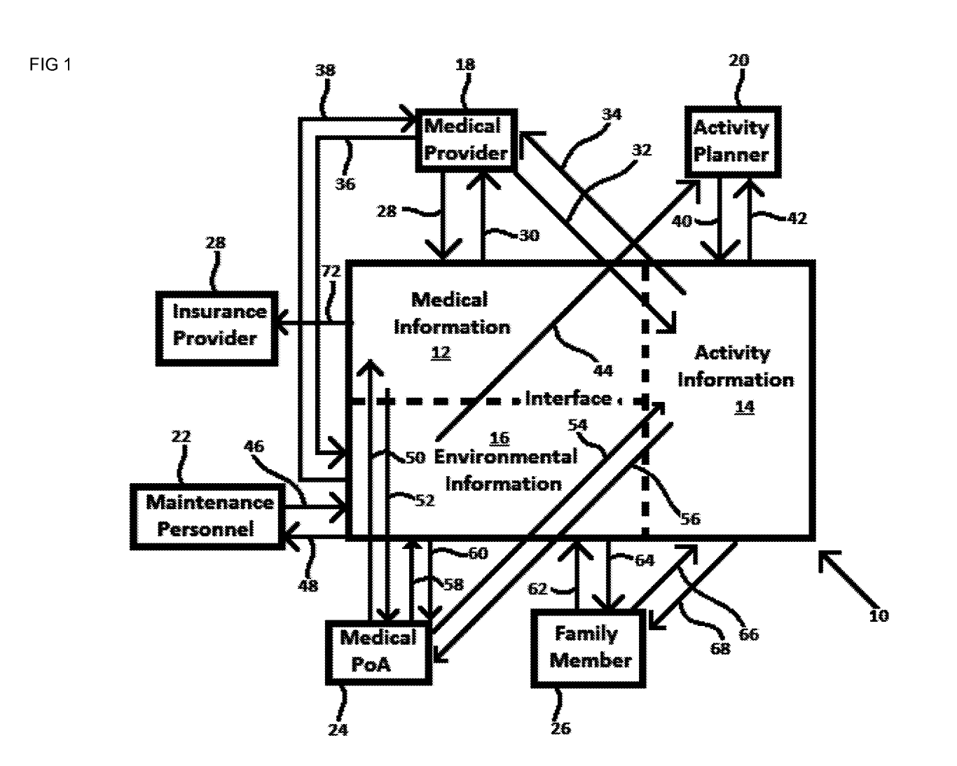

FIG. 1 depicts a diagrammatic view of an embodiment of a system usable within the scope of the present disclosure. The depicted system includes, generally, an informational interface (10), accessible by one or more devices. While the exemplary embodiments described herein will be described with reference to the access and manipulation of information relating to patients at an elderly care facility, it should be understood that embodiments of the systems and methods described herein can be used in conjunction with any facility, any individual, and/or any groups of facilities and/or individuals for which the secure access and manipulation of information using a centralized interface is desirable. The informational interface (10) can include, by way of example, a database of information specific to a patient, coupled with sufficient processor(s), data storage, input devices, output devices, and software to enable receipt and transmission of information to and from the interface (10). While embodiments described herein discuss the informational interface (10) as a body of information specific to a single patient, it should be understood that information relating to any number of individuals and/or facilities could be stored, accessed, and manipulated in a similar manner without departing from the scope of the present disclosure.

Information within the depicted interface (10) is shown conceptually divided into medical information (12) (e.g., related to treatment and care of a patient, procedures, recording/observation of vital signs, and the like), activity information (14) (e.g., related to present, past, and/or future activities occurring at or relating to the facility where a patient is housed), and environmental information (16) (e.g., features of a facility at which a patient resides, maintenance requests and status, conditions of a patient's home if the patient is undergoing home health care, etc.). The above-described delineations of information are merely exemplary, and have been labeled and described for illustrative purposes. Embodiments usable within the scope of the present disclosure can include other categories of information (e.g., housekeeping, compliance, etc.) in addition to, or in lieu of, any combination of the above-described categories of information.

FIG. 1 depicts six exemplary devices usable to access the interface (10), each device having differing levels of access with regard to the ability to input information to the interface (10) and to access/display or modify/edit information within the interface (10). Three of the depicted devices relate to exemplary care providers and/or staff members associated with a facility: a medical provider device (18) (e.g., accessed/used by a doctor, nurse, or similar treatment/care provider in a facility), an activity planner device (20) (e.g., accessed/used by an individual responsible for scheduling, planning, executing, and/or facilitating events/activities associated with a facility), and a maintenance personnel device (22) (e.g., accessed by personnel responsible for repairing, maintaining, upgrading, and/or otherwise equipping one or more areas of a facility with requested/desirable features). It should be understood that the above-described devices are illustrative examples of devices usable within the scope of the present disclosure, and that any number of devices usable by any individual, either directly or indirectly associated with a patient's care and/or a facility responsible for one or more patients could be used to access the interface (10), such as devices usable by a compliance officer, housekeeping personnel, administrators, and the like. In an embodiment, a patient, himself or herself, could also be authorized to access the interface (10) and to input and/or receive information.

The depicted medical provider device (18) can be representative of one or a plurality of devices, used by one or a plurality of individuals involved in the treatment and/or care of a patient. For example, doctors or nurses responsible for observing a patient, measuring a patient's vital signs, interacting with a patient, administering medication, performing a procedure, or other similar tasks, can record information relevant to a the patent's treatment/care, e.g., using a portable device such as a computer, tablet, cellular telephone, etc.

Alternatively, information could be recorded using non-digital means (e.g., handwritten) and later converted to a digital format. Additionally, medical devices (e.g., monitoring devices) could be used to automatically capture information (e.g., patient vital signs, patient mobility, etc.) periodically and/or continuously. Captured information can be transmitted, either automatically or manually, to the interface (10) (e.g., the medical information (12) section thereof), as illustrated by signal (28). In various embodiments, this information could also be transmitted to one or more authorized individuals directly (e.g., via a text/SMS message, an e-mail, a hyperlink transmitted via text/SMS message or e-mail, voice message, a message sent using a mobile application, etc.), concurrent with, or subsequent to, the provision of the signal (28) to the interface (10). Alternatively or additionally, the information could be transmitted directly to one or more authorized individuals, from the interface (10) itself (e.g., upon its transmission to the interface (10), the information could be subsequently transmit to one or more other devices).

The signal (28) can be representative of any manner of medical information relating to a patient, including, without limitation, patient vital signs and/or observations, orders for medical procedures, prescriptions, care and/or treatment instructions, responses to questions of the patient and/or individuals associated with the patent (e.g., family members), responses to questions of other staff members, and other similar types of information.

FIG. 1 also illustrates a second signal (30), representing the transmission of information from the medical information (12) portion of the interface (10) to the medical provider device (18). The first and second signals (28, 30) indicate that the medical provider device (18) has a sufficient input level to add information to the medical information (12) portion of the interface (10) (e.g., for access by others), and a sufficient access level to access (e.g., display) information contained within the medical information (12) portion of the interface (10).

In a similar manner, the medical provider device (18) is shown transmitting a signal (32) to the activity information (14) portion of the interface (10) and receiving a signal (34) therefrom, representing that the depicted medical provider device (18) has a sufficient input level to add information to the activity information (14) portion of the interface (10) (e.g., for access by others), and a sufficient access level to access (e.g., display) information contained within the activities information (14) portion of the interface (10). For example, signal (32) could represent a doctor or other care provider inputting a restriction on a patient's physical activities, or a recommendation that a patient undertake certain types of activities (e.g., cardiovascular exercise), and this information would subsequently be accessible by other individuals having a sufficient access level to access and display the activity information (14) portion of the interface (10). Similarly, signal (34) can represent the ability of the medical provider device (18) to access existing information (e.g., patient registration and attendance at activities).

The medical provider device (18) is further shown transmitting a signal (36) to the environmental information (16) portion of the interface (10) and receiving a signal (38) therefrom, representing that the depicted medical provider device (18) has a sufficient input level to add information to the environmental information (16) portion of the interface (10) (e.g., for access by others), and a sufficient access level to access (e.g., display) information contained within the environmental information (16) portion of the interface (10). For example, signal (36) could represent a care provider inputting a request that a certain feature be installed in a patient's room (e.g., a medically necessary item of furniture), or a maintenance request relating to a feature that is damaged or otherwise in need of preventative of reparative maintenance. Signal (38) could represent a care provider having access to the status and/or features of a patient's room.

As such, FIG. 1 illustrates the medical provider device (18) as an exemplary device having the ability to access and input information into all depicted portions of the interface (10).

The depicted activity planner device (20) can be representative of one or a plurality of devices, used by one or a plurality of individuals involved in the planning, scheduling, execution, and/or facilitation of events and/or activities associated with a facility. For example, various staff members at a facility responsible for event planning and related activities can input information relating to activities (e.g., title, date, time, location on or off of the facility premises, any notes relating to the event, etc.), and this information can be transmitted to the activity information (14) portion of the interface (10), as illustrated by signal (40). Other relevant information relating to activities may include health benefits associated therewith, one such measure of health benefits being the “Dimensions of Wellness” (social, emotional, spiritual, environmental, occupational, intellectual, and physical) that may be affected/influenced by an activity. In addition to transmission of information relating to facility activities to the interface (10), such information can be transmitted to one or more authorized individuals directly (e.g., via a text/SMS message, e-mail, a hyperlink transmitted via text/SMS message or e-mail, voice message, a communication via an application for a mobile device, etc.). Alternatively or additionally, the information could transmit directly to one or more authorized individuals, from the interface (10) itself (e.g., upon its transmission to the interface (10), the information could be subsequently or concurrently transmitted to one or more other devices). Signal (40) may also represent the transmission of attendance by patients at an activity, as well as any associated observations, input, etc.

FIG. 1 also illustrates a further signal (42), representing the transmission of information from the activity information (14) portion of the interface (10) to the activity planner device (20). The signals (40, 42) illustrate that the activity planner device (20) has a sufficient input level to add information to the activity information (14) portion of the interface (10) (e.g., for access by others), and a sufficient access level to access (e.g., display) information contained within the activity information (14) portion of the interface (10). An additional signal (44) is shown being transmitted from the environmental information (16) portion of the interface (10) to the activity planner device (20), representing that the activity planner device (20) has a sufficient access level to access (e.g., display) information contained within the environmental information (16) portion of the interface (10). For example, an individual involved in the planning/coordination of activities could query the status and/or features of a patient's location (e.g., to determine suitability thereof).

The lack of a signal from the activity planner device (20) to the environmental information (16) portion of the interface (10) is indicative that in the depicted embodiment, the activity planner device (20) lacks a sufficient input level to add information to the environmental information (16) portion. Similarly, the lack of signals between the activity planner device (20) and the medical information (12) portion of the interface (10) is indicative that, in the depicted embodiment, the activity planner device (20) lacks sufficient input or access levels to access the medical information (12) portion. It should be understood that the restrictions placed on the access of the activity planner device (20) are illustrative of a single, non-limiting embodiment of a configuration of a usable system.

The depicted maintenance personnel device (22) can be representative of one or a plurality of devices, used by one or multiple individuals associated with the preventative or reparative maintenance of a facility, the installation and/or removal of features (e.g., furniture, medical equipment, etc.), and other similar tasks. For example, a medical professional may submit a request for a special item of furniture or piece of medical equipment to be installed in a patient's room at a facility, or a patient or family member may request that a damaged feature in a patient's room be repaired, and this information could be input into the environmental information (16) portion of the interface (10). The maintenance personnel device (22) can access such information, as illustrated by signal (48). In an embodiment, information can be transmitted directly to a maintenance personnel (e.g., via a text/SMS message, e-mail, a hyperlink transmitted via text/SMS message or e-mail, voice message, or similar means) when input into the interface (10). After an installation, repair, or similar task is completed, the maintenance personnel device (22) can transmit information relevant to this undertaking to the environmental information (16) portion of the interface (10), as represented by signal (46).

The lack of signals between the maintenance personnel device (22) and the medical and activity information (12, 14) portions of the interface (10) is indicative that in the depicted embodiment, the maintenance personnel device (22) lacks sufficient input and access levels to add or access/display information from the medical and activity information (12, 14) portions.

Accordingly, FIG. 1 illustrates the activity planner device (20) and maintenance personnel device (22) as exemplary devices having limited authorization to access and input information into the interface (10).

Three of the depicted devices relate to exemplary individuals authorized by a patient at a facility to input and/or access all or a portion of the information in the interface (10) relevant to the patient. Specifically, FIG. 1 depicts a device (24) representative of one or more individuals having medical power of attorney for the patient, a device (26) representative of one or multiple family members of the patient, and a device (26) representative of an insurance provider at least partially responsible for payment on behalf of the patient. It should be understood that the depicted devices are illustrative, non-limiting examples of devices usable within the scope of the present disclosure, and that any individual can be authorized or not authorized to access any portion of the interface (10) without departing from the scope of the present disclosure.

The power of attorney device (24) can be representative of one or a plurality of devices, used by one or multiple individuals having medical power of attorney for a patient. It should be understood that reference to individuals having medical power of attorney is merely an illustrative example of an embodiment of a system usable within the scope of the present disclosure, and that any individual could be provided with or restricted from any access level and/or input level independent of whether the individual is granted medical power of attorney for a patient. Information stored in the medical information (12) portion of the interface (10) can be accessed (e.g., displayed, printed, and/or otherwise viewed by a individual), as illustrated by signal (60). Alternatively or additionally, the information could received directly by an authorized individual, from a medical provider or via the interface (10) (e.g., upon its transmission to the interface (10), the information could be subsequently transmit to one or more other devices).

FIG. 1 also illustrates signal (58), representing the transmission of information from the power of attorney device (24) to the medical information (12) portion of the interface (10). For example, an individual having medical power of attorney could transmit instructions and/or directives for access by staff members, and/or could transmit questions to be reviewed and answered by staff members, e.g., via a HIPAA-complaint, real-time chat interface. The signals (58, 60) illustrate that the power of attorney device (24) has a sufficient input level to add and/or modify information to the medical information (12) portion of the interface (10) (e.g., for access by others), and a sufficient access level to access (e.g., display) information contained within the medical information (12) portion of the interface (10).

The power of attorney device (24) is also shown receiving a signal (56) from the activity information (14) portion of the interface (10) and transmitting a signal (54) thereto, representing that the depicted power of attorney device (24) has a sufficient input level to add and/or modify information to the activity information (14) portion of the interface (10) (e.g., for access by others), and a sufficient access level to access (e.g., display) information contained within the activities information (14) portion of the interface (10). For example, signal (56) could include one or more activities relevant to a patient, and associated information (location, date, time, health benefits, etc.) input by a staff member for review by authorized parties, while signal (54) can include registration of one or more attendees (e.g., a patient and/or relatives/friends thereof), questions regarding an activity for review by staff members, and other similar types of information.

The power of attorney device (24) is further shown receiving a signal (60) from the environmental information (16) portion of the interface (10) and transmitting a signal (58) thereto, representing that the depicted power of attorney device (24) has a sufficient input level to add and/or modify information to the environmental information (16) portion of the interface (10) (e.g., for access by others), and a sufficient access level to access (e.g., display) information contained within the environmental information (16) portion of the interface (10). For example, signal (58) could represent a request for repair, maintenance, cleaning, and/or other types of activities to be performed on a certain feature of a patent's room, and/or any questions relating to features within a patient's room and maintenance/repairs thereof, while signal (60) could represent a review of a patient's accommodations, the status of any maintenance requests, and the like.

As such, FIG. 1 illustrates the power of attorney device (24) having the ability to access and input information into all depicted portions of the interface (10).

The depicted family member device (26) may be representative of one or a plurality of devices, used by one or a plurality of family members, friends, relatives, etc. associated with the patient, whom the patient desires to authorize to access at least a portion of the information relating to the patient in the interface (10). In the depicted exemplary embodiment, a distinction is made between the power of attorney device (24) and the family member device (26); however, it should be understood that a medical power of attorney can be granted to family members, friends, or any other individual, and that any level of access to the interface (10) can be provided to or withheld from any individual, independent of the existence of a power of attorney or other directive, and independent of the manner of relationship between the authorized individual(s) and the patient. For example, various friends and/or relatives of a patient may be involved with a patient's treatment or care, or may wish to attend activities at a facility with a patient, and as such, may be authorized to access relevant information in the interface (10).

In the depicted example, the family member device (26) is shown receiving information from the activity information (14) portion of the interface (10), as illustrated by signal (68). For example, a friend and/or relative of a patient may be authorized to access information indicating the date, time, location, and/or other information relevant to an activity at a facility. In an embodiment, such information could be received directly by one or more authorized individuals (e.g., via a text/SMS message, e-mail, a hyperlink transmitted via text/SMS message or e-mail, voice message, etc.), either directly from the party inputting the information or via the interface (10). Signal (66) can represent the transmission of information from the family member device (26) to the activity information (14) portion of the interface. For example, a relative and/or friend associated with a patient may be authorized to register to attend an activity, register a patient to attend an activity, input questions relating to an activity for access by other individuals (e.g., staff members), and other similar tasks.

The family member device (26) is also shown receiving information from the environmental information (16) section of the interface (10), as illustrated by signal (64). For example, a friend and/or relative of a patient may be authorized to access information relating to a patient's room at a facility, the features thereof, and/or the status of maintenance/repair requests. Signal (62) can represent the transmission of information from the family member device (26) to the environmental information (16) portion of the interface (10). For example, a friend and/or relative of a patient may be authorized to submit questions relating to a patient's room and/or features of a facility, and/or to submit maintenance/repair requests.

The lack of signals between the family member device (26) and the medical information (12) portion of the interface (10) is indicative that in the depicted embodiment the family member device (26) lacks sufficient input and access levels to add or access/display information from the medical information (12) portion.

The depicted insurance provider device (28) is shown receiving a signal (72) from the medical information (12) portion of the interface (10). The signal (72) can be representative of the insurance provider device (28) having authorization to accent patient-specific healthcare information, e.g., for the purpose of payment and/or approval thereof. The lack of a signal from the insurance provider device (28) to the medical information (12) portion is indicative that in the depicted embodiment, the insurance provider device (28) lacks a sufficient input level to input information to the medical information (12) portion of the interface (10). In various embodiments, however, it should be understood that the insurance provider device (28) could be authorized to submit questions regarding treatment, care, procedures, etc., approvals and/or denials of coverage, other types of insurance information, payment and/or associated documents, and the like to the medical information (12) portion.

The lack of signals shown between the insurance provider device (28) and the activity and environmental information portions (14, 16) of the interface (10) is indicative that in the depicted embodiment, the insurance provider device (28) lacks sufficient input and access levels to add or access/display information from the activity and environmental information portions (14, 16).

As such, FIG. 1 illustrates the family member device (26) and insurance provider device (28) as exemplary devices having limited authorization to access and input information into the interface (10).

One possible embodiment of a system usable within the scope of the present disclosure can include a HIPAA-compliant chat interface, by which medical providers, other staff members, and/or other authorized individuals may publish patient-specific information in a centralized location, while family members and/or other authorized individuals associated with the patient can access the interface to view the information, and submit questions, instructions, responses, notes, journal entries, or similar items of information to the interface to be viewed by staff members and/or other authorized individuals. Exchanges of information via such a chat interface can occur contemporaneously, e.g., in real-time.

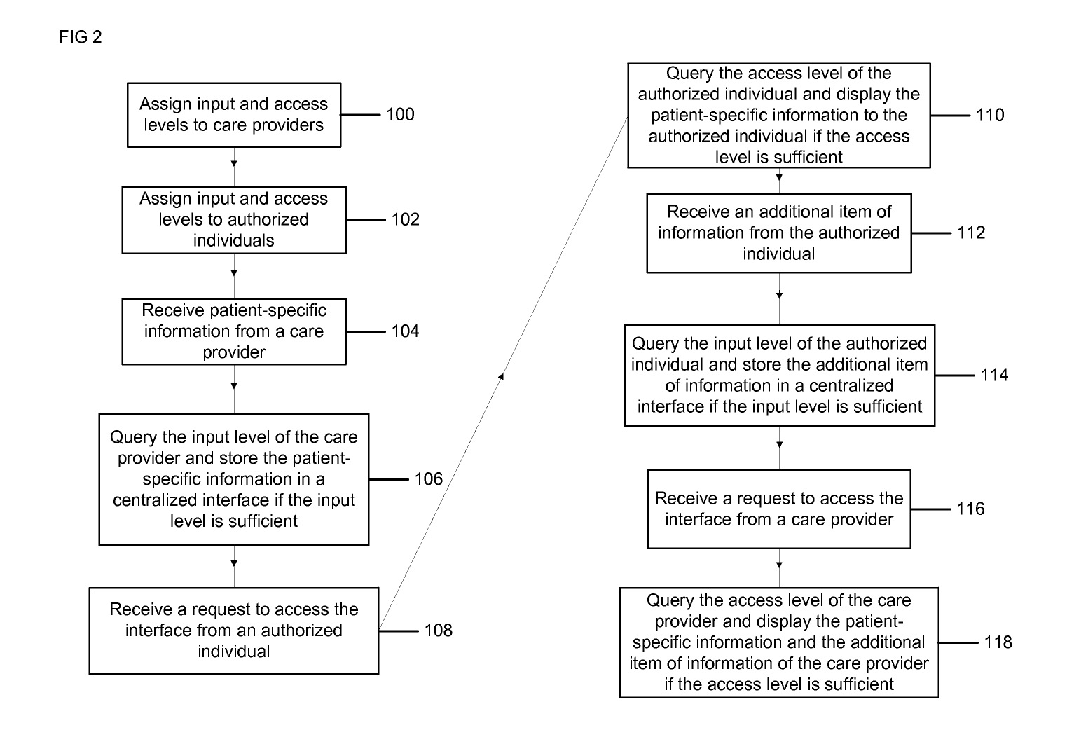

FIG. 2 depicts an embodiment of a method usable within the scope of the present disclosure that can encompass such a chat interface. In the depicted method, a plurality of care providers (e.g., medical providers, facility staff members, activity planners, maintenance and/or housekeeping personnel, and/or other individuals associated with a facility and/or with a patient's care) are authorized to access the interface through the assignment of input and access levels thereto (100). As described above, the input level associated with a care provider can determine the portions of a centralized interface, if any, to which the care provider may transmit information for storage and access by other authorized individuals, while the access level of a care provider can determine the portions of the centralized interface that can be accessed and displayed to that care provider.

In a similar manner, one or more other individuals (e.g., family members of a patient, friends, and/or other individuals associated with a patient) may be authorized to access the interface, e.g., through the assignment of input and access levels thereto (102).

In the embodiment depicted in FIG. 2, patient-specific information can be received from a care provider (104). For example, a medical provider may observe and/or treat a patient, record vital signs or other medical data, and/or otherwise interact with a patient, prescribe a course of treatment or a product, or render medical instructions, then transmit this patient-specific information to the centralized interface. Upon doing so, the input level of the care provider can be queried, and the patient-specific information can be stored in the interface if the input level is sufficient to do so (106). The patient-specific information may thereafter be accessible for display and/or review by other individuals having access to the interface.

For example, in the embodiment shown in FIG. 2, a request to access the interface from an authorized individual can be received (108). Authorized individuals may include other medical providers, staff members, and/or other care providers, as well as relatives, friends, family members, and/or other individuals associated with the patient and authorized to receive personal health information related to the patient. The access level of the authorized individual may be received by the system, and the patient-specific information can be displayed to the individual if the individual's access level is sufficient (110). For example, a relative of the patient could access and display information relevant to a patient's medical condition and course of treatment that was previously input by a care provider.

In the embodiment illustrated by FIG. 2, additional information can be received from authorized individual (112). For example, a relative of the patient could input a question relating to the patient-specific information into the interface, a person having medical power of attorney for the patient could input a directive or other instructions, or a care provider could comment, question, or otherwise elaborate on the patient-specific information. The input level of the authorized individual can be queried, and the additional item of information can be stored in the centralized interface if the individual's input level is sufficient (114).

A subsequent request to access the interface can be received from a care provider (116) (e.g., the care provider referenced previously with regard to steps 104 and 106, or a different care provider), the access level of the care provider can be queried, and the patient-specific information and the additional item of information can be displayed to the care provider if the access level is sufficient (118). It should be understood that while FIG. 2 references a care provider in steps 116 and 118, any individual possessing the requisite access level could subsequently access the interface and view the patient-specific information and the additional information also included herein.

The method depicted in FIG. 2 thereby illustrates one possible embodiment of a chat interface, by which authorized individuals (e.g., facility staff members, relatives/friends of a patient, etc.) can access a single centralized body of information, input information (contingent on the input level of each individual), and display/review information (contingent on the access level of each individual). As such, the interface can function as a chat system by which authorized individuals can communicate medical information, questions, responses, instructions, and the like, e.g., as a real-time, contemporaneous chat, and such information can be viewed by multiple authorized parties to ensure that all authorized parties are aware of each communication. As described above, in various embodiments, when information is inputted into the interface, the information can also be simultaneously sent directly to one or more authorized parties, e.g., via a text/SMS message, e-mail, a hyperlink transmitted via text/SMS message or e-mail, voice message, a message via a mobile application, or a similar medium. Alternatively, an individual may simply receive a notification that new information has been transmitted to the interface, or may receive the information, itself, via the interface rather than directly from the transmitting party. In an embodiment, information can be broadcast, e.g., simultaneously transmitted to multiple individuals via one or multiple media.

Another embodiment of a system usable within the scope of the present disclosure can include an activities application by which care providers (e.g., activity planners at a facility) can publish information regarding activities associated with a facility, receive registrations for attendees, and record attendance of patients and/or other individuals, while family members and/or other authorized individuals associated with patients can access the interface to view the information, submit questions, receive manual or automatic reminders regarding activity times and/or notifications regarding attendance of patients, and the like. Embodiments can include generation of reports relating to health benefits of activities (e.g., “Dimensions of Wellness”). Such reports can be patient-specific (e.g., tracking the attendance of an individual patent at various activities having selected characteristics), or activity-specific (e.g., tracking the attendance at various activities having selected characteristics).

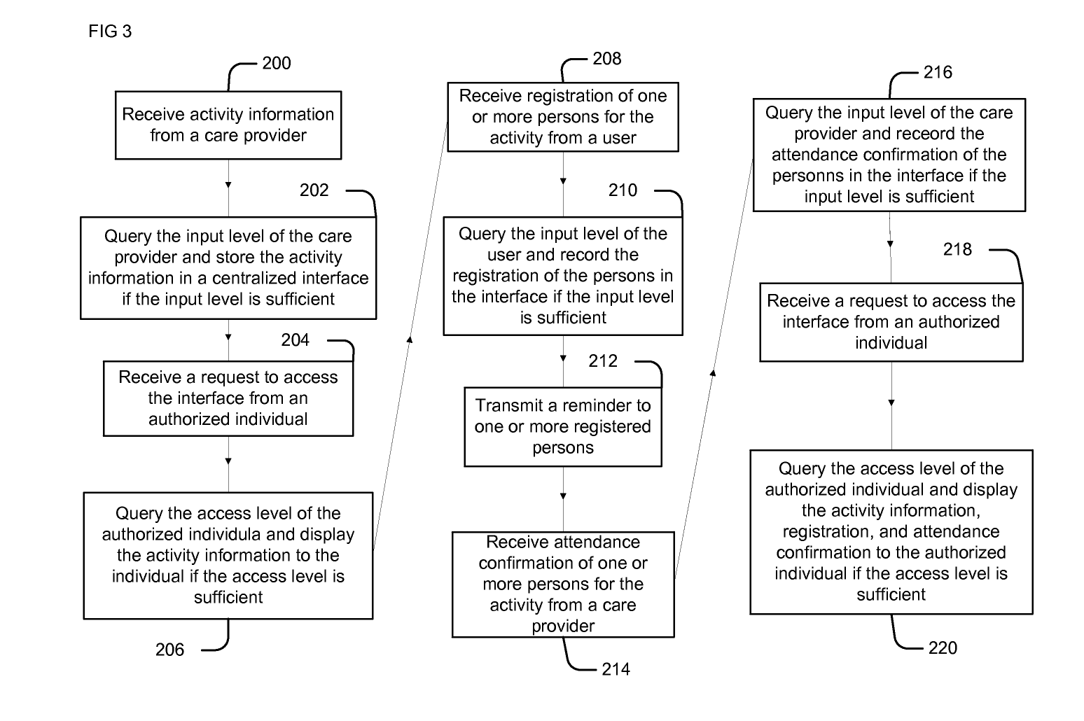

By way of example, FIG. 3 depicts an embodiment of a method usable within the scope of the present disclosure that can encompass an activities application/interface. In the depicted method, activity information can be received from a care provider (200). Such information may include, for example, a title of an activity, the date and time thereof, the location thereof, and any associated notes regarding the activity. Activities can also be classified as reoccurring or one-time events, or any other desired designation, such as being assigned health benefits, such as “Dimensions of Wellness,” and/or otherwise flagged or categorized. The input level of the care provider can be queried, and the activity information can be stored in a centralized interface if the input level of the care provider is sufficient (202).

In the embodiment illustrated in FIG. 3, a request to access the interface may be received from an authorized individual (204), the access level of the individual can be queried, and the activity information can be displayed to the individual if the individual's access level is sufficient (206). For example, a patient, a relative thereof, other care providers, or any other user of the system could become informed regarding one or more activities by accessing the interface, which can serve as a collective repository of information for a plurality of activities.

Registration of one or more persons (e.g., patients, relatives, etc.) can be received from a user (208). In various embodiments, a care provider (e.g., the activity planner or another individual) could register participants, and/or patients or authorized individuals associated therewith could transmit a registration to the interface. The input level of the individual in question can be queried, and the registration of the persons can be transmitted to the interface if the input level is sufficient (210).

In an embodiment, a reminder (e.g., a text/SMS message, e-mail, a hyperlink transmitted via text/SMS message or e-mail, telephone/voice message, a message sent via a mobile application, or similar means) could be transmitted to one or more registered persons and/or other authorized individuals (212). For example, a preselected time interval prior to the scheduled time of the activity could be selected, e.g., by the care provider inputting the activity and/or by one or more registrants or individuals associated therewith, and the interface could transmit a reminder at a time corresponding to the time interval.

During or after completion of the activity, an attendance confirmation for one or more persons for the activity can be received from a staff member or attendance monitoring device (214). The input level of the care provider or attendance monitoring device can be queried, and the attendance confirmation can be recorded in the interface if the input level of the care provider or attendance monitoring device is sufficient (216).

At a subsequent time, a request to access the interface can be received from an authorized individual (218) (e.g., a care provider, patient, friend/relative of a patient, or other authorized individual), the access level of the individual can be queried, and the activity information, registration, and attendance confirmation can be displayed to the authorized individual if the access level is sufficient (220). For example, an authorized family member of a patient could view a record of each activity attended by the patient, possibly categorized by “Dimensions of Wellness” or other categories (e.g., date, location, etc.)

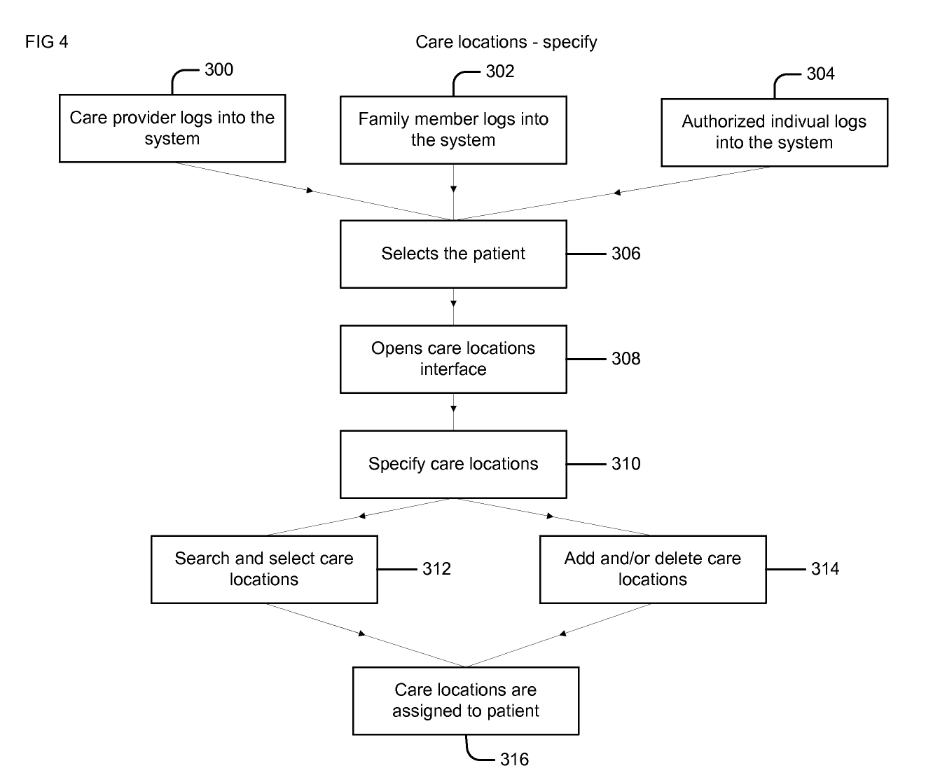

FIG. 4 depicts an embodiment of the present disclosure, wherein authorized individuals are able to access the system and input information specifying the care location of a specific patient. Authorized individuals, such as the care provider, family members of the patient, and/or other authorized individuals (300, 302, and 304) may access the system by logging into the interface. Once logged into the system the authorized individual may select the patient whose information they are attempting to access and/or modify (306). Once the relevant patient is selected the system opens a care locations interface (308). The authorized individual may then be able to search for and/or select the care location(s) that are relevant to the selected patient (312) and either add or delete which of the care location(s) are associated with the patient (314). The system can then assign the relevant care locations to the selected patient (316), and such care location information may subsequently be accessed by persons having the requisite access level.

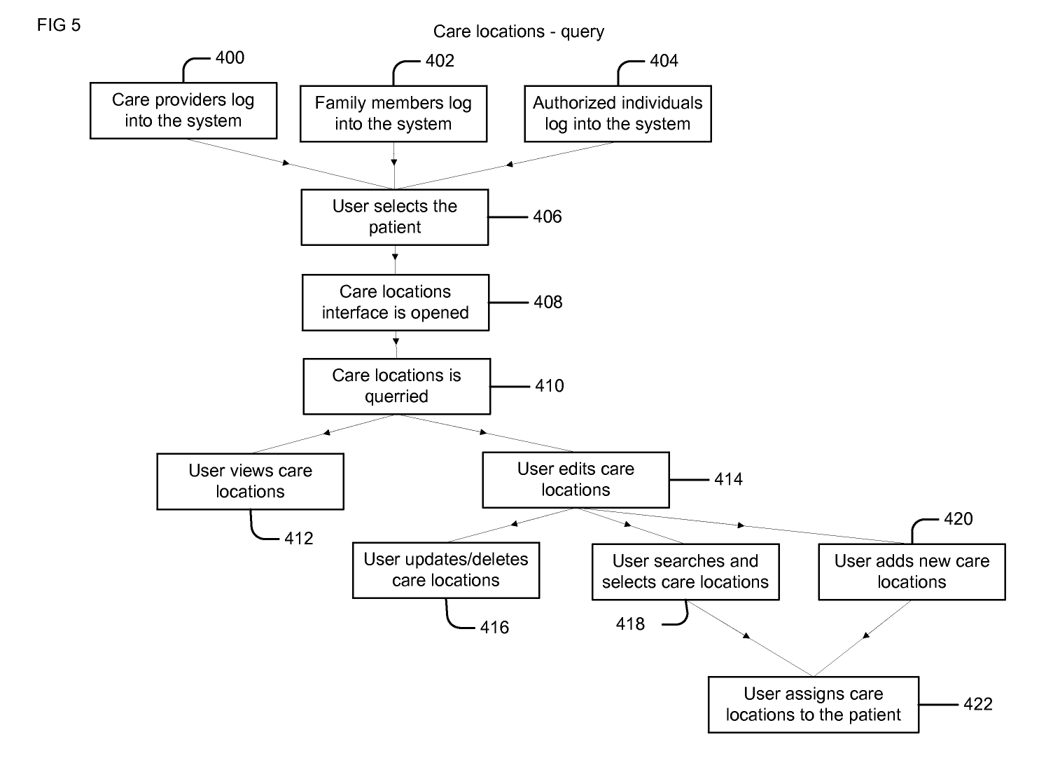

FIG. 5 illustrates an embodiment of the present disclosure wherein the system may be queried as to the care locations associated with a patient. Authorized individuals, such as the care provider, family members of the patient, and/or other authorized individuals may access the system by logging into the interface (400, 402, and 404). The authorized individual(s) then may then select the patient whose care location they are wishing to query (406). The care locations interface associated with the selected patient is then opened (408). The interface then displays the care locations that the system has associated with the selected patient (412). If the individual has a sufficient access level the individual may edit the care locations that the system has associated with the selected patient (414). This editing/modifying of care locations associated with the selected patient may include updating the care locations that the system has associated with the selected patient (416), deleting any care locations that the system has associated with the selected patient (416), searching for other care locations that are known to the system (418), and/or adding new care locations to the system (420). The authorized individual may then assign one or more of the known or new care locations to the selected patient (422).

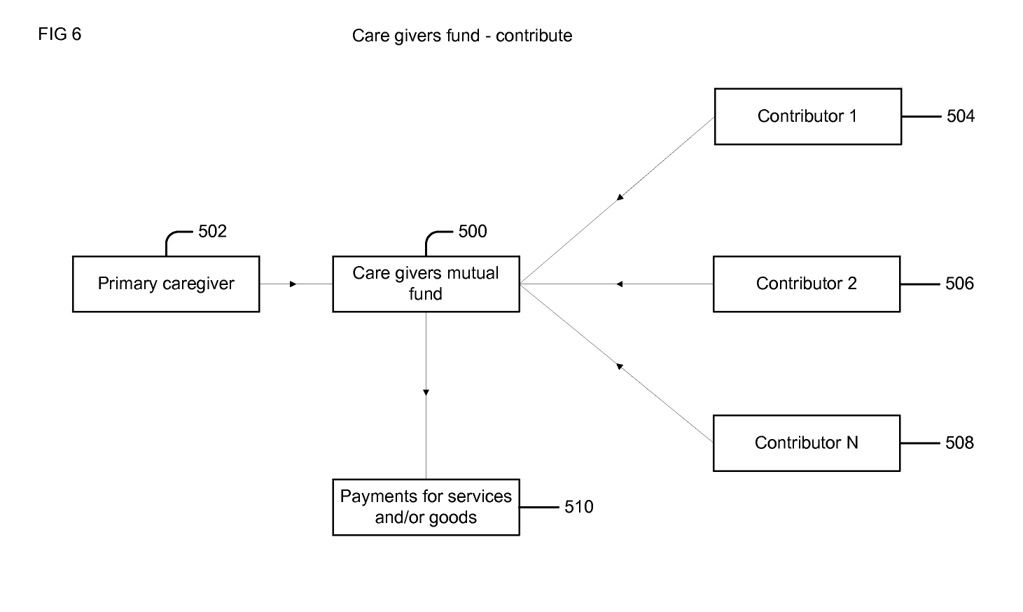

FIG. 6 delineates an embodiment of the present disclosure, wherein the system may be used to enable authorized contributors to contribute to a mutual fund (500) for the benefit of a patient. The primary caregiver or other individual with the requisite input level (502) establishes a care givers mutual fund (500) within the system. In FIG. 6 the direction of the arrows in the flow diagram indicate the potential flow of moneys through the care givers mutual fund embodiment of the system. Authorized contributors (504, 506, and 508) are then able to contribute money to the mutual fund (500) by virtue of their level of authorization. The money in the mutual fund (500) may then be used for payment of goods and/or services for the benefit of the patient associated with the care givers mutual fund (500).

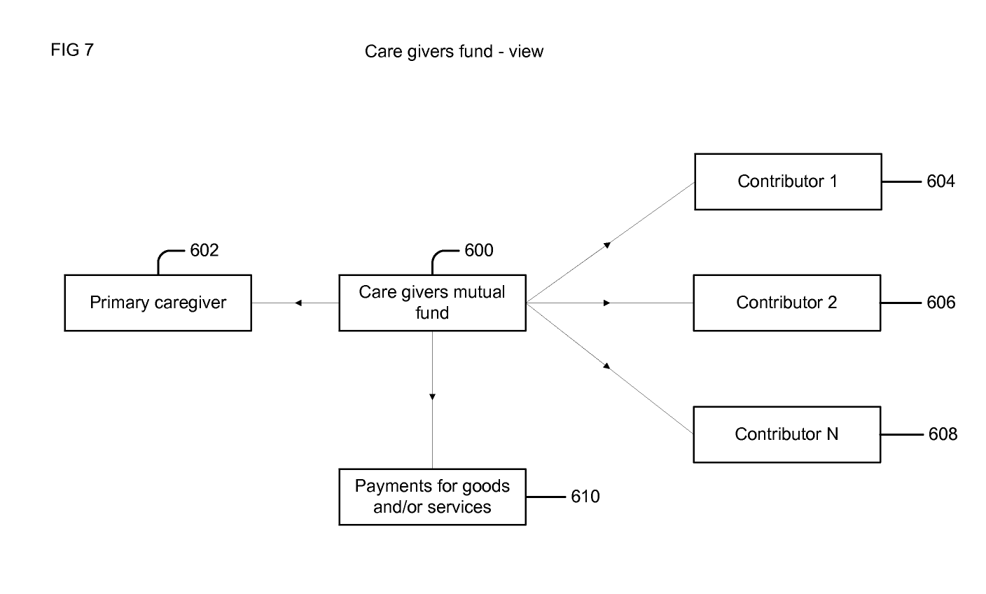

FIG. 7 shows a manner in which the embodiment of the system which provides for a care givers mutual fund may allow for the distribution of funds from the mutual fund to be monitored by authorized individuals, and specifically by those who contributed funds to said mutual fund. Once the care givers mutual fund (600) has been established those with appropriate access levels, including the primary caregiver (602) and any authorized contributors (604, 606, and 608) may view the status of the funds in the mutual fund (600) and see the distributions made from the mutual fund (600) for the payment of goods and/or services for the betterment of the patient for which the mutual fund (600) was established. Embodiments of this system may provide for scenarios wherein an individual may be authorized to contribute to the mutual fund (600), but not authorized to view status of the fund itself or of the payments made to or from the fund (600). Alternative embodiments may provide for scenarios wherein an individual may be authorized to monitor the status of the fund and allocation of fund resources, but not be authorized to contribute to the mutual fund (600). Additional or alternative embodiments may require a further access level in order to manage the mutual fund (600).

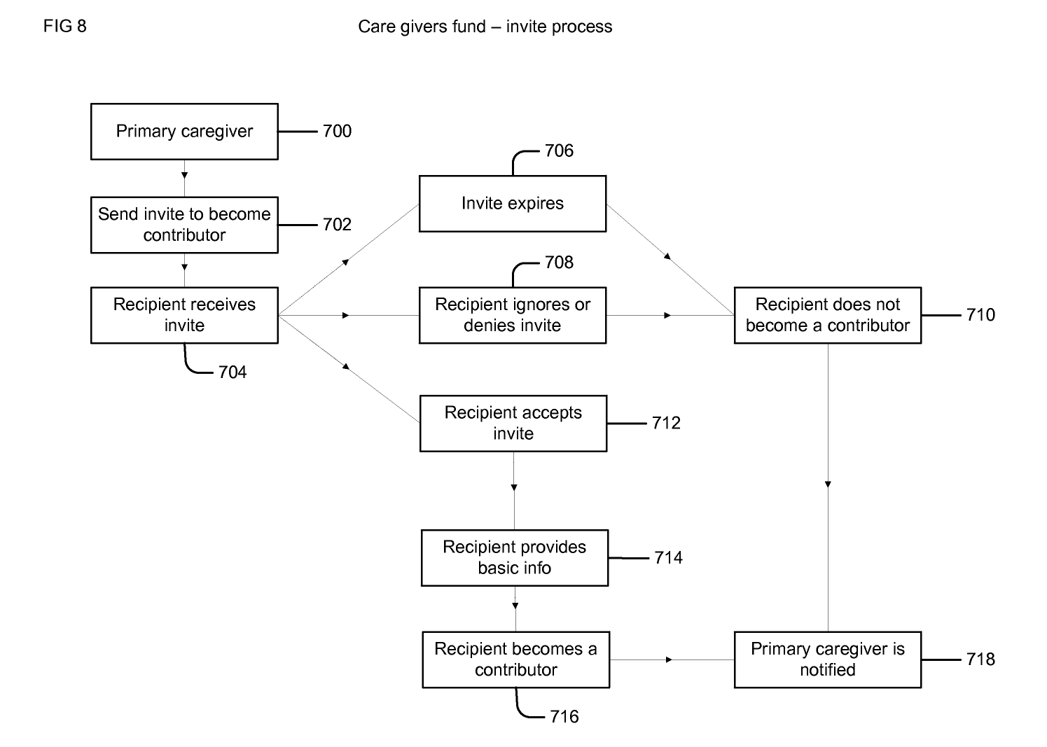

FIG. 8 depicts an exemplary manner of how an individual may become authorized to contribute funds to a care givers mutual fund. The primary caregiver (700) sends an invitation to become an authorized contributor (702) to a mutual fund established for the benefit of a patient in the system to a previously unauthorized individual. The unauthorized individual then receives the invention to become an authorized contributor (704). If the unauthorized individual fails to accept the invite then the unauthorized individual remains unauthorized to contribute to the mutual fund (710) and the primary caregiver (700) is notified (718). The unauthorized individual's failure to accept the invitation may be due to an intentional denial of the initiation (708), or the failure to accept the invitation within a set time period, after which the initiation is considered to have expired (706). If the unauthorized individual accepts the invitation (712) the unauthorized individual may be prompted for basic information related to their contributing to the mutual fund (714). Such basic information may include, but is not limited to, their name, address, credit card information, bank information, etc. Once this basic information is received the previously unauthorized individual receives the input level and/or access level offered by the primary caregiver, and may, for example, contribute to the mutual fund (716) and the primary caregiver is notified (718)

Embodiments of the system depicted in FIG. 8 may provide for the amount of time before the expiration of the invitation to be a variable that is set by the authorized individual issuing the invitation.

While FIG. 8 is described with particular reference to authorization to become a contributor to a mutual fund, it should be understood that the authorization process exemplified in FIG. 8 may be applied to any authorization for any embodiment of the system within the scope of this disclosure. This embodiment simply illustrates one embodiment of a method by which a previously unauthorized individual may receive input and/or access levels for the system.

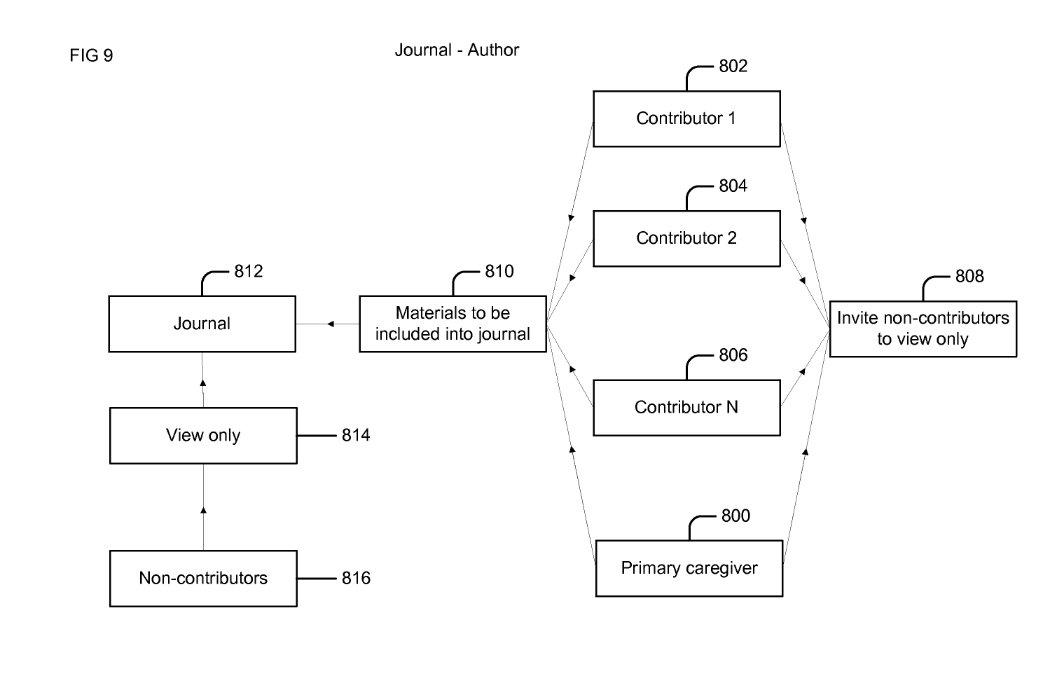

FIG. 9 depicts a flowchart of an exemplary embodiment of the system in which authorized individuals may contribute to a journal related to a particular patient. In such an embodiment authorized individuals (802, 804, and 806), including the primary caregiver (800) may use the interface to submit materials (810) to be included into the journal (812) related to the particular patient. Authorized contributors (800, 802, 804, and 806) may also be authorized to invite non-contributors to view the journal (808). It should be noted that different levels of authorization may provide for authorized individuals to be authorized to submit materials (810) to the journal (812) but not be authorized to invite non-contributors to view the journal (808), or vice versa. Alternatively or in addition, there may be access levels that allow for authorized individuals to both invite non-contributors to view the journal (808) and to submit materials to the journal (810). In the event that a non-contributor (816) is invited to view the journal (812) they may be limited to only viewing the journal (814) and not being able to add to, or modify it.

Materials (810) that may be included in a journal (812) as described in the embodiment shown in FIG. 9 may include, but are not limited to, stories, photographs, videos, notes, comments, feedback, and edits related to the same.

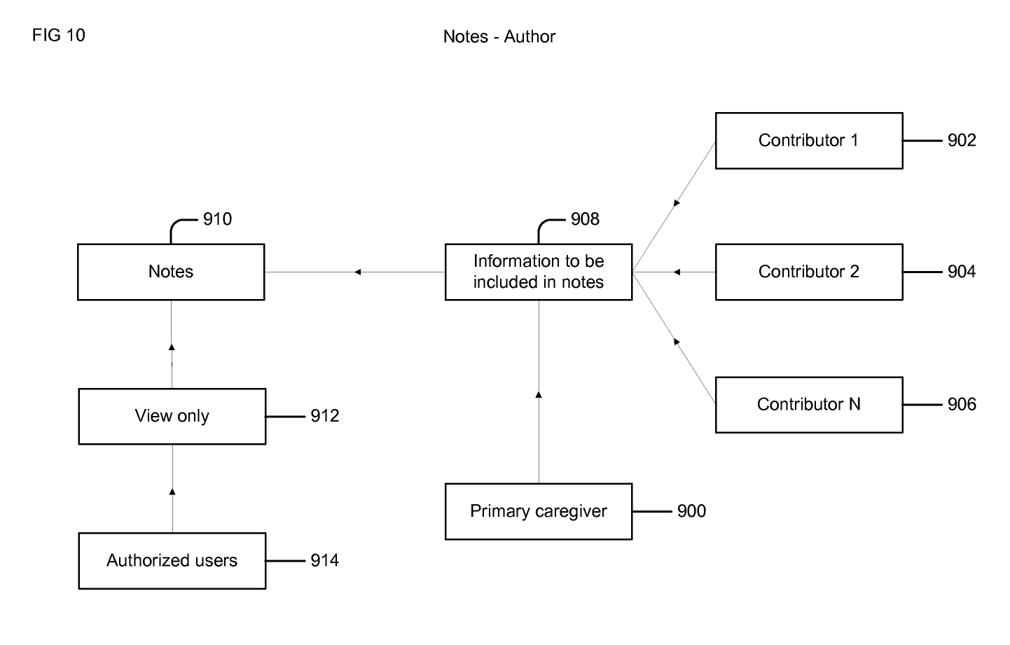

FIG. 10 illustrates an embodiment of the system in which authorized individuals are able to make notes related to the patient in the system. Individuals may be authorized to contribute to the notes, to only view the notes, or may not be authorized to have any access to the notes. Individuals authorized to contribute to the notes (902, 904, and 906), including the primary caregiver (900) may submit information to be included in the notes (908) to the system through the interface. If their authorization is valid the information to be included in the notes (908) will be included in the notes (910). Individuals who are authorized to view the notes, but who are not authorized to contribute to the notes (914) may only view (912) the notes (910) but will not be allowed to provide, delete, or edit the notes (910).

Different embodiments of this system may provide for different access levels that allow for the authorized individual to take only a single action, to take a combination of actions, or to take any action that may be allowed by the system, depending on the access level of the individual and the access level required by the different tasks to be undertaken. It is conceivable, and to be included in the scope of this disclosure, that any combination or permutation of actions requiring authorization may be facilitated by different access levels within the system.

Embodiments usable within the scope of the present disclosure are thereby usable to facilitate the creation, maintenance, and use of HIPAA-compliant, centralized repositories of information, accessible by authorized individuals to determine the most current and most complete health information related to patients, and/or activities undertaken by patients associated with a facility. Embodiments are usable as a chat interface, e.g., to exchange questions and other information with medical personnel and/or other staff members. Other embodiments are usable as an activities application/system, e.g., to track patient attendance at activities associated with a facility, and receive associated reminders and notifications.

While various embodiments usable within the scope of the present disclosure have been described with emphasis, it should be understood that within the scope of the appended claims, the present invention can be practiced other than as specifically described herein.

1. A method for securely communicating information regarding a patient, the method comprising the steps of:
authorizing a plurality of accounts to access an informational interface specific to the patient, wherein authorizing the plurality of accounts comprises assigning each of the plurality of accounts an access level and an input level;
receiving information specific to the patient from at least one of the plurality of accounts;
transmitting the information to the informational interface, based on the input level of the at least one of the plurality of accounts;
displaying the information in the informational interface to at least one other of the at least one of the plurality of accounts based on the access level of said at least one other of the plurality of accounts.

2. The method of claim 1, further comprising the step of transmitting the information at least one of the plurality of accounts, wherein the transmitting comprises transmitting an e-mail, a text/SMS message, a voice message, a hyperlink for accessing the informational interface, a message to a mobile device using a software application stored thereon, or combinations thereof.

3. The method of claim 1, further comprising the steps of receiving a communication from at least one of the plurality of accounts, transmitting the communication to the informational interface, and displaying the communication to at least one other of the plurality of accounts based on the access level of said at least one other of the plurality of accounts.

4. The method of claim 1, wherein the information comprises a time criteria, the method further comprising the step of transmitting a notification to at least one of the plurality of accounts, the patient, or combinations thereof at a time corresponding to a preselected time interval prior to the time criteria.

5. The method of claim 1, further comprising the steps of authorizing the patient to access the informational interface and displaying the information in the informational interface to the patient.

6. A system for securely communicating information regarding a patient, the system comprising:
a personnel database comprising plurality of accounts, wherein each account comprises an access level and an input level associated therewith; and
an informational interface adapted to receive information specific to the patient from accounts based on the input level associated with the accounts and to display the information to accounts based on the access level of the accounts;
data storage comprising information specific to the patient and computer instructions for instructing a processor in communication with the data storage and the informational interface to:
receive information from an account;
query the input level associated with the account;
transmit the information to the informational interface, at least one of the account, or
combinations thereof based on the input level associated with the account;
receive an access request from at least one additional account;
query the access level associated with the at least one additional account; and
display the information to said at least one additional account based on the access level of said at least one care account.

7. The system of claim 6, wherein the personnel database further comprises contact information associated with at least one of the accounts, and wherein the computer instructions instruct the processor to transmit the information to an e-mail address associated with the contact information, a telephone number associated with the contact information via a text/SMS message, a telephone number associated with the contact information via a voice message, an account associated with an application stored on a mobile device, or combinations thereof.

8. The system of claim 6, wherein the computer instructions further instruct the processor to receive a communication from at least one of the accounts and display communication to at least one other of the accounts based on the access level of said at least one other of the accounts.

9. The system of claim 6, wherein the information comprises a time criteria and a preselected time interval associated therewith, and wherein the computer instructions instruct the processor to transmit a notification to at least one of the accounts at a time corresponding to the preselected time interval prior to the time criteria.

10. The system of claim 6, wherein the accounts comprise a patient account, and wherein the computer instructions instruct the processor to receive an access request from the patient account, query an access level of the patient account, display the information to the patient account.

11. The system of claim 6, wherein the informational interface is configured as a mutual fund established for the benefit of the patient, and wherein the accounts may view, contribute to, manage, or be prevented from viewing the mutual fund, or some combination thereof based on the access levels associated with the accounts.

12. The system of claim 6, wherein the informational interface is configured as journal, and wherein the accounts may view, contribute to, manage, or be prevented from viewing the journal, or some combination thereof based on the access levels associated with the accounts.

13. The system of claim 6, wherein the informational interface is configured as notes, and wherein the accounts may view, contribute to, manage, or be prevented from viewing the notes, or some combination thereof based on the access levels associated with the accounts.

14. Computer instructions stored in a non-transitory data storage medium which, when executed by a processor in communication with the non-transitory data storage medium, instruct the processor to perform the steps of:
receive information regarding a patient from an account stored in a database;
query an input level in the database associated with the account to form a first determination;
transmit the information to a telephone number associated with at least one account in the database via a text/SMS message, a hyperlink for accessing the database, a telephone number associated with said at least one account via a voice message, an e-mail address associated with said at least one account, or combinations thereof based on the first determination;
store the information in association with an informational interface in the database;
receive an access request from at least one additional account in the database;
query an access level in the database associated with said at least one additional account to form a second determination; and
display the information using the informational interface and a display device associated with said at least one additional account based on the second determination.

15. The computer instructions of claim 14, wherein the computer instructions when executed by a processor in communication with the non-transitory data storage medium, further instruct the processor to:
receive a communication from at least one account in the database and store the communication in the non-transitory data storage medium;
receive an access request from the at least one account in the database to form a fourth determination; and
display the communication using the informational interface and a display device associated with said at least one account based on the fourth determination.

16. The computer instructions of claim 14, wherein the computer instructions when executed by a processor in communication with the non-transitory data storage medium, further instruct the processor to:
receive a time criteria and a preselected time interval associated with the information;
transmit a notification to at least one account at a time corresponding to a preselected time interval prior to the time criteria.

17. The computer instructions of claim 14, wherein the computer instructions when executed by a processor in communication with the non-transitory data storage medium, further instruct the processor to:
receive an access request from a patient account in the database associated with the patient;
query an access level of the patient account to form a fifth determination;
display the information using the informational interface and a display device associated with the patient account based on the fifth determination.
